(19) United States
(12) Patent Application Publication
(10) Pub. No.: US 2011/0102466 A1
(43) Pub. Date: May 5, 2011

(54) SYSTEM AND METHOD FOR ZOOMING IMAGES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/779,702

(22) Filed: May 13, 2010

(30) Foreign Application Priority Data
Oct. 29, 2009 (CN) 200910309041.8

(51) Int. Cl. G09G 5/00

(52) U.S. Cl. 345/660

(57) ABSTRACT

A system for zooming images includes a mobile device, an acceleration sensor, and a processing unit. The mobile device displays an image. The acceleration sensor is mounted to the mobile device, to sense an acceleration of the mobile device, and to generate displacement data of the mobile device according to the acceleration. The processing unit is connected to the mobile device and the acceleration sensor, to receive the displacement data from the acceleration sensor, and to zoom in or zoom out the image according to the displacement data.

### BACKGROUND

1. Technical Field

The present disclosure relates to systems and methods for image processing, and particularly to a system and method for zooming images.

2. Description of Related Art

Nowadays, most mobile devices, such as mobile phones and personal digital assistants, have the feature of being able to display selected images. Although a feature of being able to adjust the size of the image may be included, it is usually accomplished by pressing a zoom in/out function key or manipulating a scroll bar with a touch pen, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several view.

FIG. 1 is a schematic block diagram of a first exemplary embodiment of a system for zooming images.

FIG. 2 is a schematic block diagram of a second exemplary embodiment of the system for zooming images.

FIG. 3 is a flowchart of a first exemplary embodiment of a method for zooming images.

FIG. 4 is a flowchart of a second exemplary embodiment of the method for zooming images.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

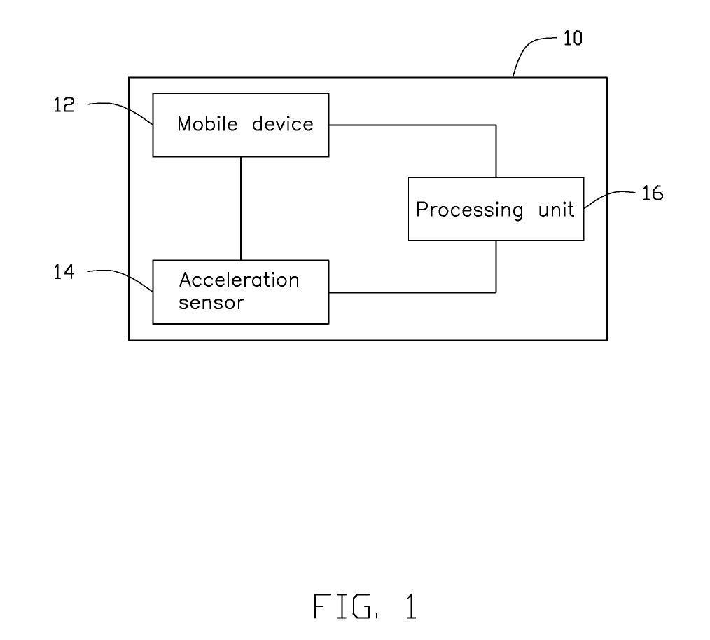

Referring to FIG. 1, a first exemplary embodiment of a system 10 is provided for zooming images. The system 10 includes a mobile device 12, an acceleration sensor 14, and a processing unit 16. The mobile device 12 is used to display images. The acceleration sensor 14 is mounted to the mobile device 12 to sense acceleration of the mobile device 12, and to generate displacement data of the mobile device 12 according to the acceleration. The processing unit 16 is connected to the mobile device 12 and the acceleration sensor 14, to receive the displacement data from the acceleration sensor 14, and to zoom an image displayed on the mobile device 12 according to the displacement data. In one embodiment, the mobile device 12 may be a mobile phone, a handheld computer, a handheld game console, or a personal digital assistant. The acceleration sensor 14 may be mounted to the mobile device 12 internally or externally.

The displacement data includes a direction and a distance of displacement of the mobile device 12. The processing unit 16 determines whether to zoom out or zoom in the image according to the direction of the displacement, and determines a zoom rate according to the distance of the displacement. When the acceleration sensor 14 senses that the mobile device 12 moves away from a user, the processing unit 16 zooms out the image displayed on the mobile device 12, and when the acceleration sensor 14 senses that the mobile device 12 moves toward the user, the processing unit 16 zooms in the image displayed on the mobile device 12. The zoom ratio of the image is proportional to the distance of the displacement, that is, the greater the distance of the displacement, the greater the zoom ratio performed. In this embodiment, maximum magnification and minification of the image can be set by the processing unit 16. If the zoom ratio reaches the maximum magnification of the image, size of the image remains the same, even though the acceleration sensor 14 senses that the mobile device 12 moves toward the user. Similarly, if the zoom ratio reaches the maximum minification of the image, size of the image remains the same, even though the acceleration sensor 14 senses that the mobile device 12 moves away from the user.

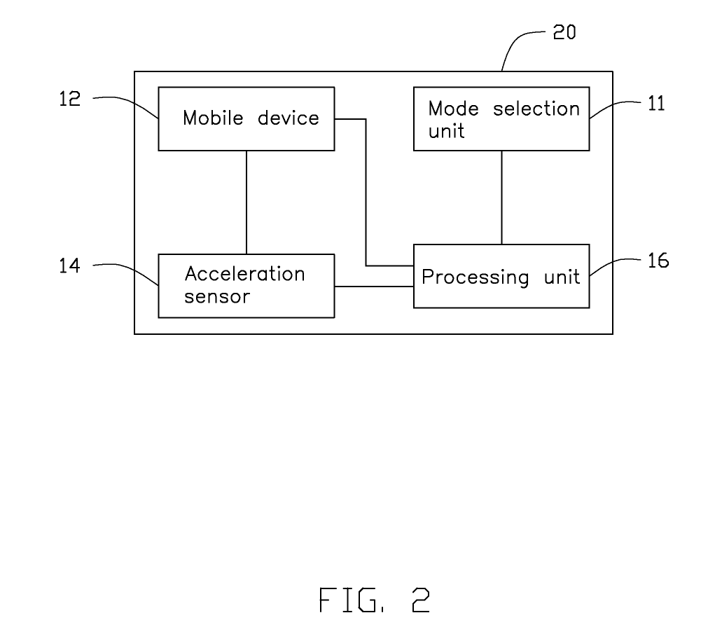

Referring to FIG. 2, a second exemplary embodiment of a system 20 is provided for zooming images. The system 20 is similar to the first embodiment of the system 10, except that the system 20 further includes a mode selection unit 11. The mode selection unit 11 is connected to the processing unit 16. A plurality of image display modes are stored in the processing unit 16. Each image display mode includes an image resolution and a corresponding image zoom rate. The user can select an image display mode to display an image via the mode selection unit 11. For example, if the user selects an image display mode with image resolution equaling to the maximum resolution supported by the mobile device 12, the image displayed on the mobile device 12 is initially at maximum minification. Therefore, even if the acceleration sensor 14 senses that the mobile device 12 is moving away from the user, size of the image displayed on the mobile device 12 cannot be further minified. If the user selects an image display mode with image resolution less than the maximum resolution supported by the mobile device 12, then when the acceleration sensor 14 senses that the mobile device 12 moves away from the user, the image displayed on the mobile device 12 is minified.

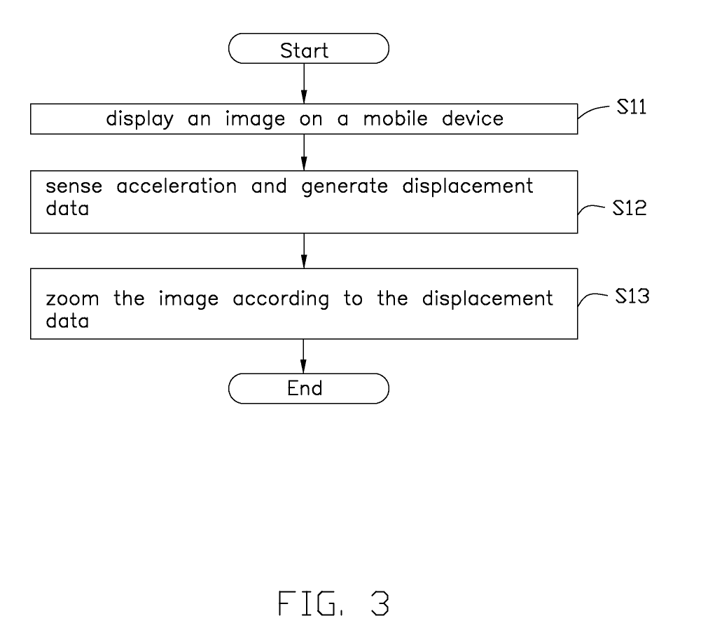

Referring to FIG. 3, a first exemplary embodiment of a method for zooming images is applied in the system 10, the method includes the following steps.

In step S11, the mobile device 12 displays an image.

In step S12, the acceleration sensor 14 senses acceleration of the mobile device 12, and generates displacement data of the mobile device 12 according to the acceleration.

In step S13, the processing unit 16 receives the displacement data from the acceleration sensor 14, and zooms the image according to the displacement data.

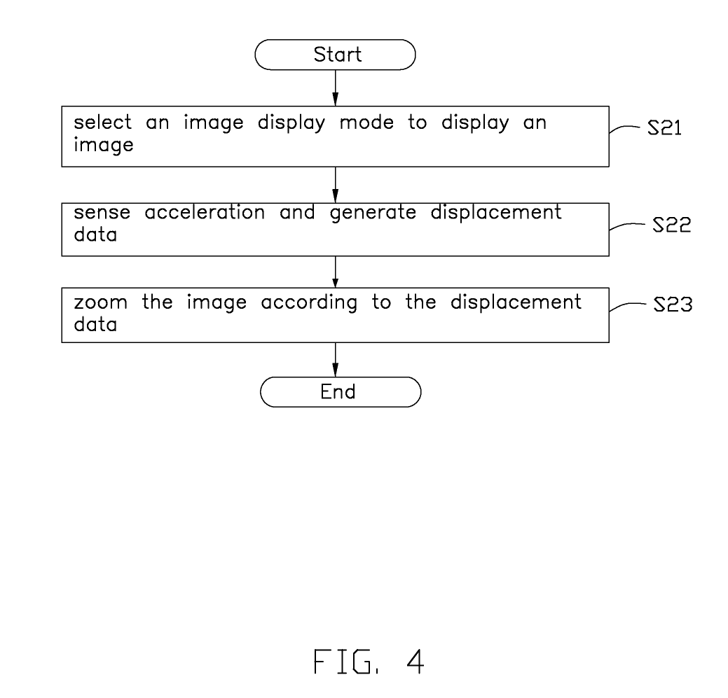

Referring to FIG. 4, a second exemplary embodiment of a method for zooming images is applied in the system 20, the method includes the following steps.

In step S21, the mode selection unit 11 is used to select an image display mode from the plurality of image display modes stored in the processing unit 16, to make the mobile device 12 display an image in a selected image display mode.

In step S22, the acceleration sensor 14 senses acceleration of the mobile device 12, and generates displacement data of the mobile device 12 according to the acceleration.

In step S23, the processing unit 16 receives the displacement data from the acceleration sensor 14, and zooms the image according to the displacement data.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A system for zooming images, comprising:
a mobile device to display an image;
an acceleration sensor mounted to the mobile device, to sense an acceleration of the mobile device, and to generate displacement data of the mobile device according to the acceleration; and
a processing unit connected to the mobile device and the acceleration sensor, to receive the displacement data from the acceleration sensor, and to zoom the image according to the displacement data.

2. The system of claim 1, wherein the displacement data comprises a direction and a distance of displacement of the mobile device.

3. The system of claim 2, wherein the processing unit determines whether to zoom out or zoom in the image according to the direction of the displacement, and determines a zoom rate according to the distance of the displacement.

4. The system of claim 3, wherein when the acceleration sensor sensors that the mobile device moves away from a user, the processing unit zooms out the image displayed on the mobile device; and when the acceleration sensor senses that the mobile device moves toward the user, the processing unit zooms in the image displayed on the mobile device.

5. The system of claim 3, wherein the zoom ratio is proportional to the distance of the displacement.

6. The system of claim 1, further comprising:
a mode selection unit connected to the processing unit, wherein the processing unit stores a plurality of image display modes, the mode selection unit is used to select an image display mode from the plurality of image display modes, to make the mobile device display the image in a selected image display mode.

7. The system of claim 6, wherein each image display mode comprises an image resolution and a corresponding image zoom rate.

8. A method for zooming images, comprising:
displaying an image on a mobile device;
sensing acceleration of the mobile device, and generating displacement data of the mobile device according to the acceleration; and
zooming the image according to the displacement data.

9. The method of claim 8, wherein the displacement data comprises a direction and a distance of displacement of the mobile device.

10. The method of claim 9, wherein zooming the image according to the displacement data comprises:
zooming out or zooming in the image according to the direction of the displacement data;
wherein a zoom rate is determined according to the distance of the displacement.

11. The method of claim 8, further comprising:
selecting an image display mode from a plurality of image display modes stored in a processing unit, to make the mobile device display the image in a selected image display mode.

12. The method of claim 11, wherein each image display mode comprises an image resolution and a corresponding image zoom rate.
